(19) United States
(12) Patent Application Publication
(10) Pub. No.: US 2026/0181122 A1
(43) Pub. Date: Jun. 25, 2026

(54) MULTI-VIEW GEOMETRIC DIFFUSION USING INCREMENTAL CONDITIONING

(71) Applicant: Toyota Research Institute, Inc., Los Altos, CA (US)

(72) Inventors: Vitor Campagnolo Guizilini, Santa Clara, CA (US); Muhammad Zubair Irshad, Milpitas, CA (US); Dian Chen, Mountain View, CA (US); Rares A. Ambrus, San Francisco, CA (US)

(73) Assignees: Toyota Research Institute, Inc., Los Altos, CA (US); Toyota Jidosha Kabushiki Kaisha, Toyota-shi Aichi-ken (JP)

(21) Appl. No.: 19/184,592

(22) Filed: Apr. 21, 2025

Related U.S. Application Data
(60) Provisional application No. 63/737,994, filed on Dec. 23, 2024.

(51) Int. Cl. H04N 13/282; G06T 7/80; H04N 13/117

(52) U.S. Cl. CPC H04N 13/282; G06T 7/80; H04N 13/117

(57) ABSTRACT

Systems, methods, and other embodiments described herein relate to generating multi-view images using intermediate views. In one embodiment, a method includes receiving a request to generate a multi-view image, the request including input data comprised of conditioning images and a target camera view for the multi-view image. The method includes generating the multi-view image according to the conditioning images and intermediate images generated between the multi-view image and at least one of the conditioning images using a model. The method includes providing the multi-view image.

### CROSS-REFERENCE TO RELATED APPLICATIONS

This application claims priority to U.S. Provisional Application No. 63/737,994 filed on Dec. 23, 2024, which is herein incorporated by reference in its entirety.

### TECHNICAL FIELD

The subject matter described herein relates, in general, to systems and methods for multi-view synthesis and, more particularly, to iteratively generating intermediate views to provide additional conditioning inputs when generating a target camera view.

### BACKGROUND

Advancements in artificial intelligence (AI) have significantly improved computer vision and other generative modeling tasks. AI-driven techniques enable novel view synthesis, allowing for the generation of new perspectives of a scene. Many approaches utilize intermediate 3D representations, such as Neural Radiance Fields (NeRF) and 3D Gaussian Splatting (3DGS), to facilitate this process. These methods construct a volumetric representation of the scene using available viewpoints and subsequently generate novel views by projecting information from the learned representation onto different perspectives.

While these techniques have demonstrated positive results, they encounter limitations when synthesizing unobserved portions of a scene. Since the generated 3D representation is explicitly conditioned on the input views, any scene information not available in those views remains absent from the model's internal understanding. As a result, when novel perspectives require details from previously unseen areas, the model struggles to generate accurate and realistic predictions. Some approaches attempt to mitigate this issue by generating additional views, refining the 3D representation to extend coverage of the environment. However, this introduces computational overhead and does not fully address the problem of missing information in the intermediate representation, which can lead to inconsistencies. Therefore, present approaches suffer from issues of accurately and efficiently generating such views.

### SUMMARY

Example systems and methods relate to multi-view synthesis using a diffusion-based model. As noted previously, current approaches to generating multi-view representations of a scene generally involve deriving an intermediate 3D representation. However, as noted, this can be computationally taxing and can also lead to issues of accuracy/consistency when deriving views of unseen viewpoints.

Therefore, in at least one arrangement, a generative system is disclosed that implements a diffusion-based model to derive multi-view images. For example, the generative system acquires input data that includes conditioning images, camera parameters, and a selected target camera view. Due to stochasticity in the diffusion process, generating predictions from unobserved viewpoints may lead to inconsistencies. Thus, in order to minimize these inconsistencies, the generative system, in at least one arrangement, generates intermediate views before generating the final multi-view image. That is, the generative system initially defines a series of intermediate views to generate before generating the multi-view image based on the target camera view of the multi-view image and viewpoints of the conditioning images. In essence, the generative system approaches generating the multi-view image by stepping closer and closer via generation of the intermediate images. For each subsequent step, the generative system uses the conditioning images along with previously generated intermediate images. To determine how to generate the intermediate images, the generative system may identify which of the conditioning images are positioned closest to the target camera view.

Once identified, the generative system can define intermediate locations for generating the intermediate images. For example, the generative system may evenly space the intermediate locations between the target camera view and the closest conditioning image. The intermediate images further condition the output, thereby enforcing consistency between the images and ensuring the multi-view image is accurate and consistent with the other images. Accordingly, the generative system functions to improve the generation of the multi-view image by iteratively generating the intermediate images as additional conditioning inputs while avoiding the complexity of rendering a 3D model or other 3D representation. In this way, the generative system is able to leverage intermediately generated images to facilitate generation of a multi-view image.

In one embodiment, a generative system is disclosed. The cognitive system includes one or more processors and a memory communicably coupled to the one or more processors. The memory stores instructions that, when executed by the one or more processors, cause the one or more processors to receive a request to generate a multi-view image, the request including input data comprised of conditioning images and a target camera view for the multi-view image. The instructions include instructions to generate the multi-view image according to the conditioning images and intermediate images generated between the multi-view image and at least one of the conditioning images using a model. The instructions include instructions to provide the multi-view image.

In one embodiment, a non-transitory computer-readable medium including instructions that, when executed by one or more processors, cause the one or more processors to perform various functions is disclosed. The instructions include instructions to receive a request to generate a multi-view image, the request including input data comprised of conditioning images and a target camera view for the multi-view image. The instructions include instructions to generate the multi-view image according to the conditioning images and intermediate images generated between the multi-view image and at least one of the conditioning images using a model. The instructions include instructions to provide the multi-view image.

In one embodiment, a method is disclosed. In one embodiment, the method includes receiving a request to generate a multi-view image, the request including input data comprised of conditioning images and a target camera view for the multi-view image. The method includes generating the multi-view image according to the conditioning images and intermediate images generated between the multi-view image and at least one of the conditioning images using a model. The method includes providing the multi-view image.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 illustrates one embodiment of a vehicle within which systems and methods disclosed herein may be implemented.

FIG. 2 illustrates one embodiment of a generative system that is associated with generating task-specific outputs using a diffusion-based model.

FIG. 3 illustrates a cloud-based environment in which the systems and methods described herein may be implemented.

FIG. 4 illustrates a diagram of a diffusion-based model.

FIG. 5 is a flowchart illustrating one embodiment of a method that is associated with generating task-specific outputs using a diffusion-based model.

FIG. 6 is a diagram of an example scene, the associated conditioning views, and a target camera view.

FIG. 7 is a flowchart illustrating one embodiment of a method that is associated with generating multi-view images using intermediate views.

### DETAILED DESCRIPTION

Systems, methods, and other embodiments are disclosed associated with multi-view synthesis using intermediate views. As noted previously, current approaches to generating multi-view representations of a scene generally involve deriving an intermediate 3D representation from which novel views are, for example, projected. However, as noted, this can be computationally taxing and can also lead to issues of accuracy/consistency when deriving views of unseen viewpoints.

Therefore, in at least one embodiment, an inventive system implements a novel paradigm for view and depth synthesis by eliminating the reliance on an explicit intermediate 3D representation. Instead, the inventive system leverages a generative model that directly synthesizes information based on a specified task from a learned generative latent representation and, in one or more approaches, by utilizing generated intermediate views to facilitate enforcing consistency between images. For example, the generative system can integrate image features and geometric embeddings to condition the learned representation, ensuring that visual information remains anchored in spatial 3D locations. By employing geometric embeddings independently of visual data, the model enables direct synthesis of new views and depth maps without requiring explicit scene reprojection. This innovation enhances the ability to generate realistic and complete scene reconstructions, further advancing AI-driven generative modeling in computer vision and beyond.

As one example, a generative system may implement a diffusion-based model to derive multi-view images. For example, the generative system acquires input data that includes conditioning images, camera parameters, and a selected target camera view. Due to stochasticity in the diffusion process, generating predictions from unobserved viewpoints may lead to inconsistencies. Thus, in order to minimize these inconsistencies, the generative system, in at least one arrangement, generates intermediate views before generating the final multi-view image. That is, the generative system initially defines a series of intermediate views to generate before generating the multi-view image based on the target camera view of the multi-view image and viewpoints of the conditioning images. In essence, the generative system approaches generating the multi-view image by stepping closer and closer via generation of the intermediate images. For each subsequent step, the generative system uses the conditioning images along with previously generated intermediate images. To determine how to generate the intermediate images, the generative system may identify which of the conditioning images are positioned closest to the target camera view.

Once identified, the generative system can define intermediate locations for generating the intermediate images. For example, the generative system may evenly space the intermediate locations between the target camera view and the closest conditioning image. The intermediate images further condition the output, thereby enforcing consistency between the images and ensuring the multi-view image is accurate and consistent with the other images. Accordingly, the generative system functions to improve the generation of the multi-view image by iteratively generating the intermediate images as additional conditioning inputs while avoiding the complexity of rendering a 3D model or other 3D representation. In this way, the generative system is able to leverage intermediately generated images to facilitate generation of a multi-view image.

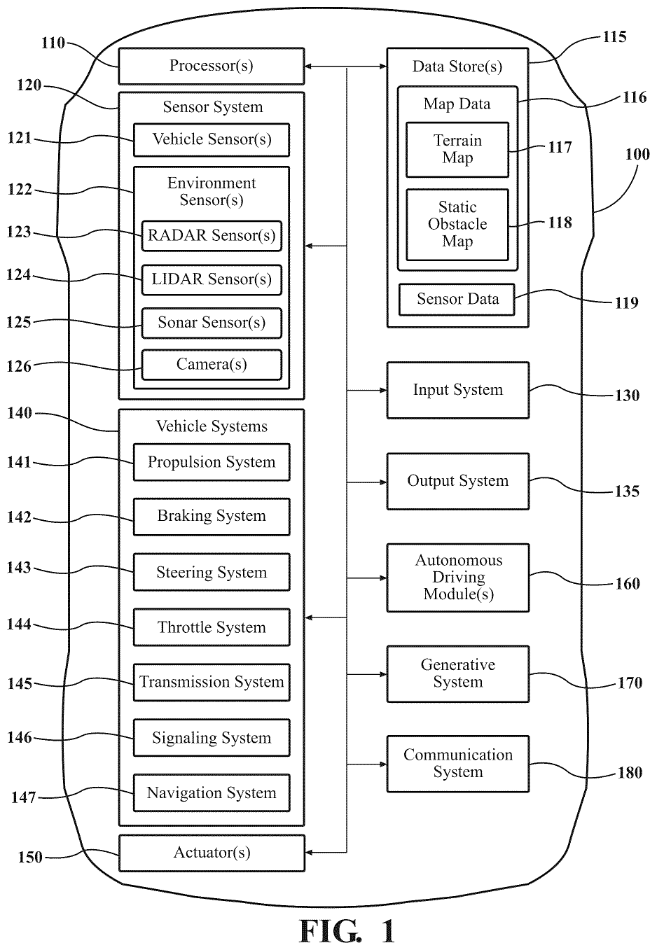

Referring to FIG. 1, an example of a vehicle 100 is illustrated. As used herein, a “vehicle” is any form of powered transport. In one or more implementations, the vehicle 100 is an automobile. While arrangements will be described herein with respect to automobiles, it will be understood that embodiments are not limited to automobiles. In some implementations, the vehicle 100 may be another electronic device (e.g., robot, static roadside unit (RSU), a server, etc.).

In any case, the vehicle 100 also includes various elements. It will be understood that, in various embodiments, it may not be necessary for the vehicle 100 to have all of the elements shown in FIG. 1. The vehicle 100 can have a different combination of the various elements shown in FIG. 1. Further, the vehicle 100 can have additional elements to those shown in FIG. 1. In some arrangements, the vehicle 100 may be implemented without one or more of the elements shown in FIG. 1. While the various elements are illustrated as being located within the vehicle 100, it will be understood that one or more of these elements can be located external to the vehicle 100. Further, the elements shown may be physically separated by large distances and provided as remote services (e.g., cloud-computing services, software-as-a-service (SaaS), distributed computing service, etc.).

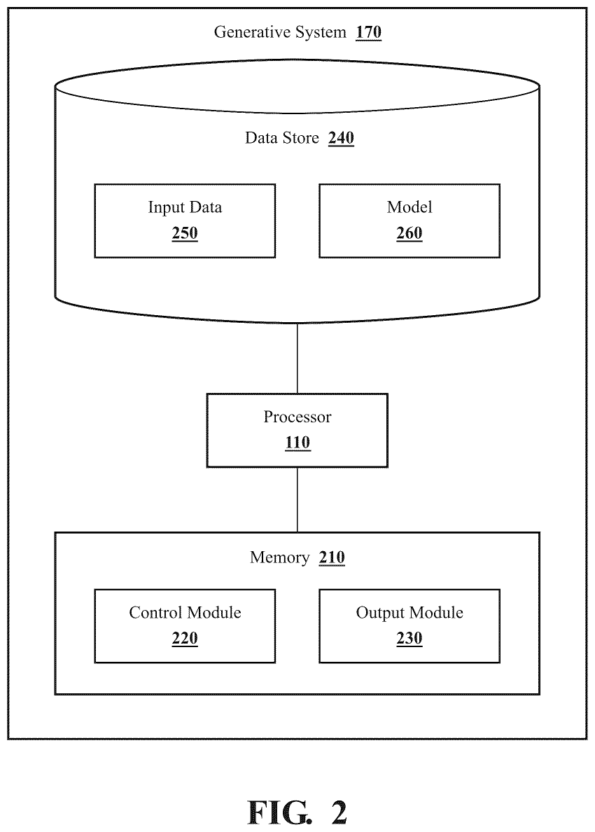

Some of the possible elements of the vehicle 100 are shown in FIG. 1 and will be described along with subsequent figures. However, a description of many of the elements in FIG. 1 will be provided after the discussion of FIGS. 2-7 for purposes of the brevity of this description. Additionally, it will be appreciated that for simplicity and clarity of illustration, where appropriate, reference numerals have been repeated among the different figures to indicate corresponding or analogous elements. In addition, the discussion outlines numerous specific details to provide a thorough understanding of the embodiments described herein. Those of skill in the art, however, will understand that the embodiments described herein may be practiced using various combinations of these elements.

In any case, the vehicle 100 includes a generative system 170 that performs multi-task generative functions, such as multi-view image generation, depth map generation, etc. While depicted as a standalone component, in one or more embodiments, the generative system 170 is integrated with other systems, such as the automated driving module 160, or another component of the vehicle 100. The noted functions and methods will become more apparent with a further discussion of the figures.

With reference to FIG. 2, one embodiment of the generative system 170 is further illustrated. The generative system 170 is shown as including a processor 110. Accordingly, the processor 110 may be a part of the generative system 170 or the generative system 170 may access the processor 110 through a data bus or another communication path. In one or more embodiments, the processor 110 is an application-specific integrated circuit (ASIC) that is configured to implement functions associated with a control module 220 and an output module 230. In general, the processor 110 is an electronic processor, such as a microprocessor, that is capable of performing various functions, as described herein. In one embodiment, the generative system 170 includes a memory 210 that stores the control module 220. The memory 210 is a random-access memory (RAM), read-only memory (ROM), a hard disk drive, a flash memory, or other suitable memory for storing the control module 220 and the output module 230. The control module 220 is, for example, computer-readable instructions that, when executed by the processor 110, cause the processor 110 to perform the various functions disclosed herein.

Furthermore, in one embodiment, the generative system 170 includes a data store 240. The data store 240 is, in one embodiment, an electronic data structure, such as a database, that is stored in the memory 210 or another memory, and that is configured with routines that can be executed by the processor 110 for analyzing stored data, providing stored data, organizing stored data, and so on. Thus, in one embodiment, the data store 240 stores data used by the control module 220 in executing various functions. In one embodiment, the data store 240 includes input data 250, a model 260, which may include multiple separate sub-models for performing different tasks, and, for example, other information that is used by the control module 220.

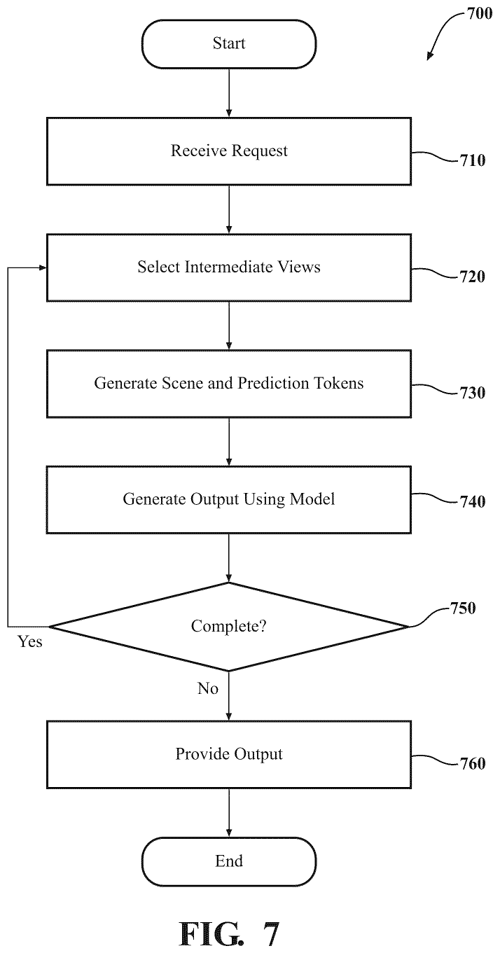

With reference to the input data 250, the input data 250 can include a wide array of different information depending on the implementation. In various approaches, the input data 250 can include conditioning images, camera intrinsics, camera extrinsics, target view information, and so on. It should be appreciated that while images are described, other modalities of environmental perception data can also be used, such as LiDAR, radar, and so on. Moreover, in further arrangements, the inputs may include dynamics data about the vehicle 100, and/or other dynamic objects in the environment. In any case, the conditioning images are, in at least one approach, RGB camera images that are captured from separate viewpoints within the environment and of the same scene. Thus, the conditioning images may be acquired via multiple cameras arranged on the vehicle 100 (e.g., eleven cameras with different viewpoints of the scene). While the conditioning images may include just a single image, in many examples, the conditioning images include two or more images in order to provide multiple views of the scene on which to condition the output. Moreover, as explained further in relation to FIG. 7, the input data 250 may be further supplemented with intermediate images generated by the model 260 and used as additional conditioning images.

The camera intrinsics include, in at least one configuration, information about a configuration of the camera itself, including focal length, pixel size, and so on. The camera extriniscs include, in at least one arrangement, a camera pose, including position and orientation. The other information included in the input data 250 is generally task specific. For example, when performing multi-view generation or depth map generation, the input data 250 includes a target camera view. The target camera view (also referred to herein as the target view) includes information specifying a viewpoint of the image/depth map that is to be generated. Thus, the information for the target camera view can include, in at least one arrangement, a pose that indicates a position and orientation of a virtual camera associated with the target camera view.

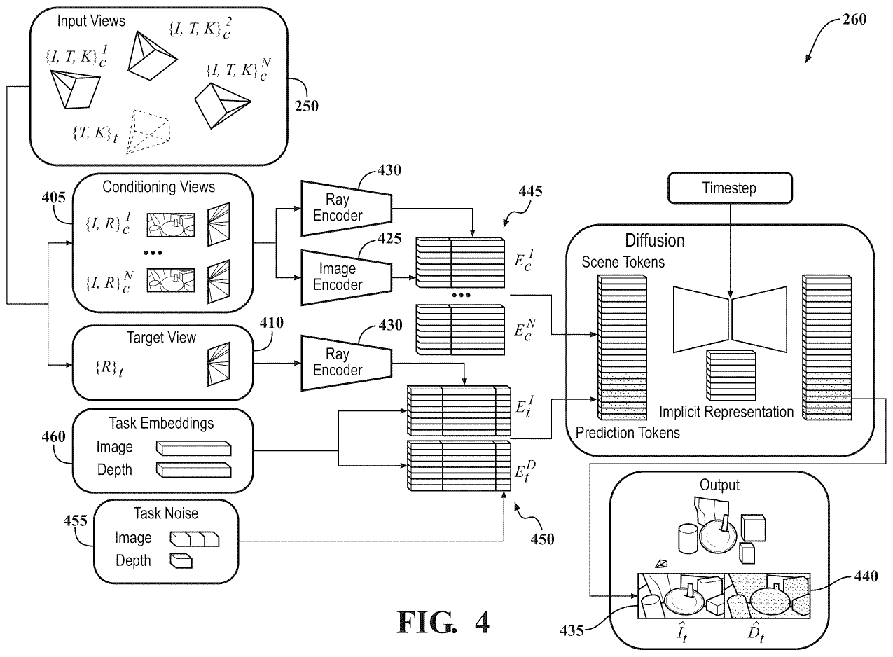

Turning to the model 260, the model 260 is, in at least one arrangement, a diffusion-based model that may include additional sub-models. For example, in one approach, the model 260 is a recurrent interface network (RIN) that may further include sub-models for pre-processing the input 250 into tokens. In one aspect, the RIN style of network is an attention-based architecture that decouples its core computation from the dimensionality of the input data 250. Thus, the RIN may focus the bulk of computation (e.g., global self-attention) on latent tokens, while using cross-attention to read and write (e.g., route) information between latent and data tokens. This permits the model 260 to accept an arbitrary number of conditioning images as input, thereby permitting adaptation to however many views of a scene are available or that are generated as the system 170 iteratively progresses toward producing a multi-view image. Additional details of the functioning of the model 260 will be described in relation to FIG. 4.

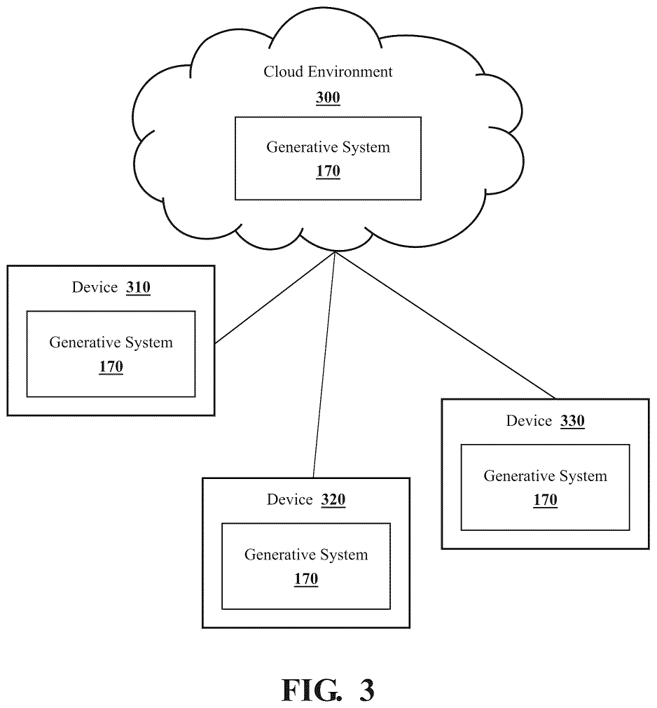

A further embodiment of the generative system 170 is illustrated in FIG. 3. As previously noted, the generative system 170 may be implemented within, for example, a cloud-based environment 300, as illustrated in relation to FIG. 3. That is, for example, the generative system 170 may acquire data (e.g., input data 250) from client instances within the devices 310, 320, and 330 and perform analysis at a remote server that is integrated as part of the cloud environment 300. Accordingly, the instances of the generative system 170 within the devices 310, 320, and 330 communicate via wired or wireless connections with the cloud environment 300. For example, the communications may be via a cellular network (e.g., Frequency-Division Multiple Access (FDMA), Code-Division Multiple Access (CDMA), etc.), a peer-to-peer (P2P) based network, WiFi, DSRC, V2I, V2V or another communication protocol that is capable of conveying the multi-modal input 250 and determinations according thereto between the entities. In this way, the devices 310-330, which may be vehicles, mobile smartphones, or other devices, can offload processing to the model 260 within the cloud environment 300.

With reference to FIG. 4, one example architecture of the model 260 is illustrated. As shown, the model 260 acquires the input data 250, which includes conditioning images, and camera parameters shown at block 405, and a target view 410. Consider the following in combination with FIG. 4. Given a collection

$${𝒥}_{C} = {\{ I , 𝒞 \}}_{n = 1}^{N}$$

of input images Iₙ∈ [symbol] ^{H×W×3} and corresponding cameras [symbol] ₙ={K, T} with camera intrinsics K∈R^{3×3} and camera extrinsics T∈R^{4×4}. The generative system 170 applies the model 260 to generate a predicted output, which for purposes of this discussion is a predicted image Î∈ [symbol] ^{H×W×3} 415 and depth map \hat{D}∈ [symbol] ^{H×W} for a novel camera [symbol] ₜ. The generative system 170 implements a diffusion-based model 260 represented as ƒ_{θ}˜p(Îₜ, \hat{D}ₜ| [symbol] ₜ, [symbol] _{c}) to learn a conditional distribution from which to sample novel target images and depth maps.

In general, diffusion models operate by learning a state transition function from a noise tensor ϵ to a sample x₀ from a learned data distribution, as shown in equation (1).

$${x}_{t} = \sqrt{{α}_{t} {x}_{0}} + \sqrt{1 - {α}_{t} ϵ} \qquad ( 1 )$$

Where

$$ϵ ∼ 𝒩 ( 0 , 𝕀 ) , {α}_{t} = {\prod }_{s = 1}^{t} ( 1 - {β}_{s} ) and {\{ {β}_{t} \}}_{t = 1}^{T}$$

is the variance schedule for a process with T steps. A neural network \hat{ϵ}=ƒ_{θ}(xₜ, t, c) is trained to estimate the noise \hat{ϵ}ₜ added to a sample x₀ at timestep t, given a conditioning variable c for controlling the generative process. At inference time, a novel x₀ is reconstructed from a normally-distributed variable x_{T}˜ [symbol] (0, [symbol] ) by iteratively applying the learned transition function ƒ_{θ} over T steps.

In at least one arrangement of the present approach, the generative system 170 implements the model 260 as a RIN, which is an efficient transformer-based architecture. The model 260 in this form accepts input tokens defined as X∈ [symbol] ^{N×D} and latent tokens Z∈ [symbol] ^{L×D} where X is obtained by the control module 220 tokenizing the input data 250, which depends on the input size N, but L is a fixed dimension. At each block of the model 260, the latents Z are first cross-attended with the inputs X, followed by several self-attention layers on Z, and the resulting latents are cross-attended back with X. Because the bulk of the computation by the model 260 (i.e., self-attention) operates on a fixed number of L latent tokens, rather than on all N input tokens, means that it is computationally feasible (i.e., adequately efficient) to learn fe directly in pixel space.

Continuing with FIG. 4, regarding the image encoder 425, in at least one approach, the generative system implements a vision transformer (ViT) to tokenize the conditioning images, thereby providing visual scene information. The image encoder 425 may be another type of network in alternative arrangements, such as a convolutional neural network (CNN). In either case, the image encoder 425 operates to encode the conditioning images into features in the form of feature vectors that are abstract representations of the images. The image encoder 425 may be pre-trained and fine-tuned for the specific tasks of the generative system 170. For example, An H×W input image I will result in

$${F}_{I} ∈ {ℝ}^{\frac{H}{4} \times \frac{W}{4} \times 448}$$

features. The image encoder 425 flattens the features and processes these by a linear layer

$${ℒ}_{448 \to {D}_{I}}^{1}$$

to produce image embeddings

$${E}_{c}^{I , n} ∈ {ℝ}^{\frac{H W}{16} \times {D}_{I}} .$$

The image encoder 425 repeats this process for each conditioning image, resulting in N sets of image embeddings.

Regarding the ray encoders 430, the control module 220 implements, in at least one configuration, Fourier encoding to tokenize camera parameters by parameterizing as a ray map including origin

$${t}_{i j k} = {[ x , y , z ]}_{k}^{T}$$

and viewing direction rᵢⱼₖ=(K_{K}Rₖ)⁻¹ [uᵢⱼ, vᵢⱼ, 1]^{T} for each pixel pᵢⱼ from camera k. The model 260 uses this information to position features extracted from conditioning images in 3D space and to determine novel viewpoints for image and depth synthesis. Conditioning cameras [symbol] ₙ are, for example, resized to match the resolution of the image embeddings, and the target camera [symbol] ₜ is kept the same (note that tₜ is at the origin, and Rₜ= [symbol] ). Assuming that Nₒ and Nᵣ origin and ray frequencies, the resulting ray embeddings are, for example, of dimensionality D_{R}=3 (Nₒ+Nᵣ+1).

As noted previously, the model 260 does not maintain an intermediate 3D representation. Instead, the model 260 generates novel renderings directly. To achieve this, in at least one configuration, the model 260 jointly learns novel view and depth synthesis by directly rendering dept maps from novel viewpoints alongside images. The model 260 uses learned task embeddings 460 E^{task}∈ [symbol] ^{D}^{ₜₐₛₖ} to guide each individual generation towards a specific task. The output predictions 435 and 440 are parameterized as follows.

For the predicted multi-view image 435, the pixel-level diffusion, in at least one arrangement, does not require latent auto-encoders. Therefore, ground-truth images are simply normalized to [−1,1] with P_{RGB}=(I+1)/2. The generative system 170 converts the generated predictions back to images using the inverse operation Î=2\hat{P}_{RGB}+1. To preserve multi-view consistency, the depth predictions 440 are scale-aware.

$${P}_{D} = 2 ( log ( \frac{D}{s \cdot {d}_{min}} ) / log ( \frac{{d}_{max}}{{d}_{min}} ) ) \qquad ( 2 )$$

$$\hat{D} = exp ( ( 2 {\hat{P}}_{D} + 1 ) log ( \frac{{d}_{max}}{{d}_{min}} ) ) {d}_{min} \cdot s \qquad ( 3 )$$

Equation (2) shows a log-scale parameterization while equation (3) shows conversions back using the inverse operation.

As described, the approach in FIG. 4 generates two sets of inputs to the model 260, including scene tokens 445 and prediction tokens 450. The scene tokens 445 contextualize the diffusion process while the prediction tokens 450 guide the diffusion process towards generating the desired predictions. The control module 220 obtains the scene tokens 445 by concatenating features of the conditioning images and ray embeddings from camera parameters associated with each conditioning image, producing

$${E}_{c}^{n} = {E}_{c}^{I , n} ⊕ {E}_{c}^{R , n} .$$

The control module 220 then concatenates embeddings from the conditioning images, which produces

$${E}_{c} = {E}_{c}^{1} ⊕ … ⊕ {E}_{c}^{N} ∈ {ℝ}^{\frac{NHW}{16} \times ( {D}_{I} + {D}_{R} )} .$$

The control module 220 generates the prediction tokens 450 by concatenating ray embeddings

$${E}_{t}^{R}$$

from the target camera view with the desired ask embeddings E^{task} and state embeddings

$${S}_{t}^{task} .$$

The state embeddings include the evolving state of the predictions of the diffusion model 260, which are defined as follows for training and inference.

In relation to training, the control module 220 generates the state embeddings St by parameterizing an input image Iₜ or depth map Dₜ, and adding random noise 455 determined by a noise scheduler n(t), given a randomly sampled timestep t∈[1, T]. The control module 220 trains the model 260 to learn the transition function ƒ_{θ}. In one or more arrangements, the control module 220 uses L2 and L1 losses to supervise image and depth generation, respectively. In relation to depth estimation, the prediction tokens 450 are, for example, generated only for pixels with valid ground-truth. For both tasks, to improve efficiency, the control module 220 randomly samples Mₚ of the prediction tokens.

In relation to inference, the control module 220 samples state embeddings

$${S}_{t}^{T} ∼ 𝒩 ( 0 , 𝕀 )$$

in at least one arrangement, iteratively denoises the vectors/scalars for T steps using fe with scheduler n (t). At t=0 state embeddings

$${S}_{t}^{0}$$

contains the parameterized prediction, which is converted back to Îₜ or \hat{D}ₜ.

Additionally, generating multiple predictions from unobserved areas can lead to inconsistencies, even though each view is, for example, equally valid. Therefore, in at least one arrangement, the generative system 170 maintains a history of generated images

$${𝒥}_{G} = {\{ \hat{I} , 𝒞 \}}_{g = 1}^{G}$$

to use as additional conditioning inputs for subsequent generation. Accordingly, after an initial generation of, for example, a multi-view image, the generated multi-view image is, for example, used as an additional input to the model 260 for generating a subsequent multi-view image, thereby enforcing consistency on subsequently generated outputs by conditioning on the input data 250 and the previously generated images. Further details of iterative generation of images is described along with FIG. 7.

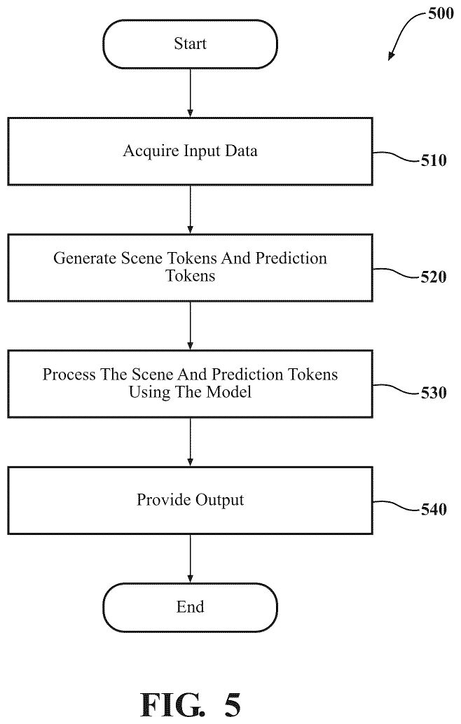

As further explanation of how the model 260 generates task-specific outputs, consider FIG. 5. FIG. 5 illustrates a flowchart of a method 500 that is associated with multi-view synthesis. Method 500 will be discussed from the perspective of the generative system 170. While method 500 is discussed in combination with the generative system 170, it should be appreciated that the method 500 is not limited to being implemented within the generative system 170 but is instead one example of a system that may implement the method 500.

At 510, the control module 220 acquires the input data 250. As previously outlined, the control module 220 acquires the input data 250 in various ways depending on the implementation. In one approach, the control module 220 acquires the input data 250 from an explicit request. Thus, the input data 250 may be embedded with the request. The request may be communicated to the generative system 170 via a communication pathway from electronic systems within a device (e.g., a vehicle, mobile device, etc.). In general, the request may relate to rendering occluded views, supplementing a model of the surrounding environment, acquiring action controls for navigating the environment, and so on.

In further arrangements, the control module 220 acquires at least a portion of the input data 250 using sensors available from the vehicle 100 and/or external sensors from other devices, which may communicate with the generative system 170 via vehicle-to-vehicle (V2V), vehicle-to-infrastructure (V2I), or other available communication standards. The content of the sensor data provided as part of the input data 250 may vary by implementation, but the control module 220 collects the sensor data to characterize the current scene, which includes aspects of the surrounding environment (e.g., obstacles). In general, the input data 250 includes at least two conditioning images, but may include an arbitrary number of views as the model 260 is able to handle different numbers of inputs because of the tokenization process and the structure of the model 260 itself. In any case, as a general premise, the control module 220 may acquire two or more conditioning images with more conditioning images improving the understanding of the scene and the output generated by the model 260.

Accordingly, while the conditioning images are generally described as camera images, in various approaches, the conditioning images may include data from other environmental perception sensors. Moreover, the input data 250 further includes camara parameters, such as camera intrinsics and camera extrinsics. As previously outlined, the camera extrinsics define information about the location and pose of the camera associated with an image and the camera intrinsics specify information about the camera itself, including focal length, pixel size, and so on. Additionally, the input data 250 includes information about a virtual camera or target camera view from which information is to be output (e.g., in the form of a multi-view image or depth map). It should be noted that the target camera view is generally selected by the requesting entity. Thus, in the case of the automated module 160 providing the request, the module 160 may select a view to acquire additional information about an occluded area. In any case, the input data 250 includes at least camera extrinsics about the target view camera. Further, it should be appreciated that the input 250 varies between training and inference. That is, during training, the input data 250 specifies a known view for which a conditioning image is available as the target view, while the actual conditioning image is not provided to the model 260 but is instead held back as a point of comparison against the output to function as the ground-truth. Of course, during inference, the ground-truth image is not available and the generative system 170 proceeds according to the specified target view.

At 520, the control module 220 generates the tokens from the input data 250. In at least one arrangement, the control module 220 generates both the scene tokens and the predictions as inputs to the model 260. As previously described, the scene tokens encode information about the scene itself, while the prediction tokens encode information about the task that the model 260 is to perform. For example, the control module 220 generates the scene tokens by encoding the conditioning images into image features and camera parameters for viewpoints of the separate conditioning views into ray embeddings. The control module 220 employees separate techniques to encode the different embeddings that form the scene tokens. In relation to the image features, the control module 220 encodes the conditioning images to generate features, which may be stored as feature vectors, that are abstract representations of the elements depicted in the images. Separately, the control module 220 uses a handcrafted technique to generate the ray embeddings. That is, the control module 220 may deconstruct the camera parameters (i.e., viewing ray) into their elements (e.g., sin/cos) to form the ray embeddings.

Once encoded, the control module 220 concatenates the image features for the separate images and the ray embeddings into the scene tokens. In general, all information belonging to an image is stacked together in one dimension as a single token. The control module 220 stacks/concatenates the information for additional images to provide additional information and increase the dimensionality. Similarly, the control module 220 concatenates ray embeddings for the target camera view along with task embeddings and state embeddings. The state embeddings are generated with, for example, Gaussian noise and these are concatenated together to form the prediction tokens. In general, the state embeddings include noise for each different channel of the output, such as one each for each separate color channel (e.g., RGB).

At 530, the control module 220 processes the scene tokens and the prediction tokens to generate an output using the model 260. The model 260 is an attention-based diffusion architecture that decouples core computations from the dimensionality of the input data. Moreover, the model 260 can also handle inputs of varying dimensionality due to the architecture, thereby supporting the input of an arbitrary number of tokens corresponding to an arbitrary number of conditioning images, which facilitates processing information about the scene in varying contexts. Overall, the model 260 processes the scene/prediction tokens into a latent representation and then back to tokens over a defined number of steps T. Because the model 260 is diffusion-based the model 260 learns a function ƒ_{θ} that learns a conditional distribution from which to sample novel target images and depth maps. In one arrangement, ƒ_{θ} learns to estimate the noise introduced via the state embeddings and how to regenerate the underlying data. In so doing, the model 260 functions in a generative way to form the multi-view image, depth map, or other information associated with the task embedding. In this way, the model 260 denoises the input tokens to generate the output.

At 540, the output module 230 provides the output. As noted, the output may take different forms depending on the task embedding. However, in general, the output is multi-view image of the scene from a defined viewpoint of the target view, a depth image of the scene from the defined viewpoint of the target view, a control sequence for controlling a device (e.g., for controlling the vehicle 100 to navigate the scene), and so on. Thus, the output module 230 may use the output to control the vehicle 100 or a robotic device (e.g., robotic manipulators).

In one embodiment, the output module 230 uses the output to form a planner representation of the environment that includes locations and other information about objects in the environment. The output module 230 may communicate the planner representation to the automated driving module 160 or another component within the vehicle 100 that functions to dynamically control operation of the vehicle 100 via steering, braking, and acceleration. Of course, in other arrangements, the output module 230 can use the output to render a visualization on a display in the vehicle or in another device that implements the system 170. The visualization may be provided as part of an ADAS function and can include a rendering of the scene showing the additional view provided as the output to facilitate, for example, visualizing occluded areas of a scene to improve situational awareness.

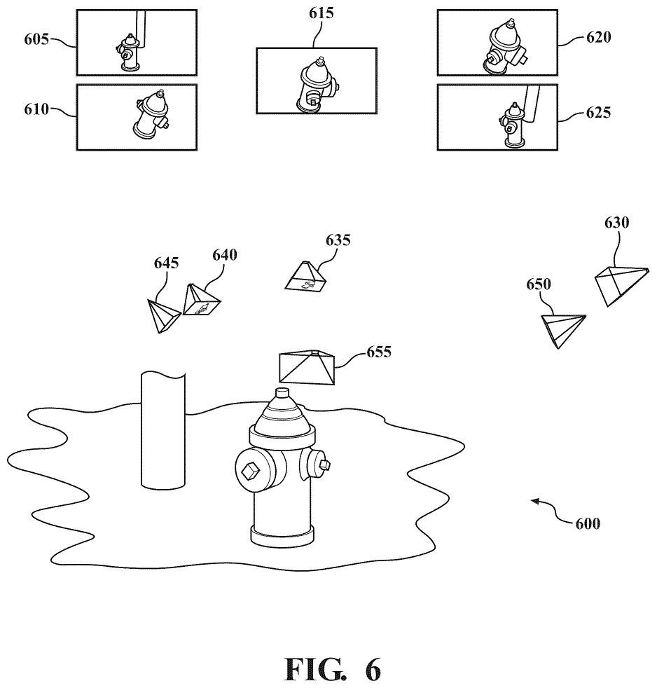

As one example of the operation of the generative system 170, consider FIG. 6, which illustrates an example 3D rendering 600 of a scene for purposes of illustration. As shown, the scene includes a fire hydrant located near a pole. The original inputs for this scene include conditioning images 605, 610, 615, 620, and 625, which correspond to views 630, 635, 640, 645, and 650, as represented by the projected pyramids. Additionally, a target view 655 is also shown. In any case, the generative system 170 is to generate an image from the perspective of the target view 655 while accepting the images 605-625 along with camera parameters from the views 630-650 as inputs. Of course, the generative system 170 also accepts information about the target view 655 and the task (i.e., multi-view image generation, depth map generation). In any case, the generative system 170 processes the inputs into the scene tokens and the prediction tokens and then applies the diffusion-based model to generate a multi-view image from the viewpoint of the target view 655. In this way, the generative system 170 is able to generate outputs without using an intermediate 3D representation.

Continuing to FIG. 7, a flowchart of a method 700 is shown that is associated with multi-view synthesis by iteratively generating intermediate images. Method 700 will be discussed from the perspective of the generative system 170. While method 700 is discussed in combination with the generative system 170, it should be appreciated that the method 700 is not limited to being implemented within the generative system 170 but is instead one example of a system that may implement the method 700.

At 710, the control module 220 receives a request to generate a multi-view image. In general, receiving the request and the information in the request (e.g., the input data 250) is similar to acquiring the input data 250 as described at block 510 of method 500. In any case, the control module 220 acquires the input data 250 from the request. Thus, the input data 250 may be embedded with the request. The request may be communicated to the generative system 170 via a communication pathway from electronic systems within a device (e.g., a vehicle, mobile device, etc.) or from a remote source. In general, as previously noted, the request may relate to rendering occluded views, supplementing a model of the surrounding environment with additional information, and so on. In one example, an automated driving module 160 may provide the request to the generative system 170 to obtain information to supplement a planning system associated with determining how to best navigate through an environment.

In any case, the request itself includes a set of conditioning images and a target camera view defining a pose/location for the multi-view image. Moreover, the input data 250 may also include camera intrinsics associated with one or more cameras that acquire the conditioning images, and camera extrinsics for the one or more cameras. Thus, within the context of the method 700, the conditioning images represent a starting point for the generative system 170. That is, for example, because the target camera view specified in the request may be from a viewpoint that the conditioning images do not fully cover, the generative system 170 can incrementally generate intermediate views to facilitate the ultimate generation of the multi-view image at the target camera view while avoiding rendering a three-dimensional model.

At 720, the control module 220 selects the intermediate views. For example, in one approach, the control module 220 initially analyzes the target camera view in relation to the available conditioning images as originally provided with the request. In essence, the original conditioning images function as anchor points for determining where to begin generation of intermediate images. Accordingly, for an initial iteration, the control module 220, in one approach, identifies a closest one of the conditioning images to the target camera view. In one arrangement, the control module 220 determines a Euclidean distance between the views of the conditioning images relative to the target camera view, then uses the closest/shortest distance to define a starting point proximate to the associated conditioning image.

Of course, the generative system 170 may undertake other approaches to selecting how to generate the intermediate images in other approaches. As one example, the control module 220 determines an equidistant point from the set of conditioning images provided in the request. That is, the control module 220 determines viewpoints for the separate conditioning images and calculates a starting point that is equidistant to the viewpoints and the target camera view. Whichever approach is undertaken, the control module 220 then defines intermediate views (i.e., locations in 3D space for generating the intermediate images) between the target camera view and the starting point (e.g., the closest location associated with the one of the conditioning images). In general, the control module 220 divides the space between the starting point and the target camera view in equally sized steps. The control module 220 may, for example, define a straight line between the target camera view and the starting point and then divide the line into equal steps. Alternatively, the control module 220 may define the steps along a curve or another shape and may also divide the space into asymmetric segments (e.g., more steps toward the beginning or end).

The number of steps (i.e., the number of intermediate images that will be generated) may depend on various factors according to the particular implementation. For example, the number of steps may be a predefined value that is based on attributes of the generative system 170 or contextual aspects of the current computational load. Thus, the number of steps may depend on a current computational load of the generative system 170, a predicted error or permissible error for the multi-view image (where more intermediate images generally decrease the overall error), and so on.

Additionally, the control module 220 generally defines the direction/pose of the intermediate images according to a salient aspect of the scene, which may be defined by the conditioning images from the request. For example, the control module 220 may project a viewing ray (e.g., a ray in a direction in which the focus and/or pose of the conditioning image is directed) of each of the conditioning images and determine a general area of intersection or an area of focus where the viewing rays pass closely (e.g., within a defined threshold distance). The control module 220 may then define this area or point as the focal point for the intermediate images. Consequently, the control module 220 defines a series of intermediate views for generating the intermediate images and a direction in which the images are to focus.

For an initial viewpoint, the control module 220 selects the intermediate view that is proximate to the conditioning images or, stated otherwise, most distant from the target camera view. For subsequent iterations, the control module 220 selects a next view in the series of defined intermediate viewpoints. In this way, the control module 220 is able to arrange the generation of the intermediate images in a logical manner to progress toward the target camera view and then ultimately selecting the target camera view to generate the multi-view image as requested.

At 730, the control module 220 generates the scene and prediction tokens for the image that is currently being generated. Overall, the control module 220 generates the tokens at 220 in the same manner as described at block 520 of method 500 with the exception of replacing the target camera view with the viewpoint of the image being generated (e.g., one of the intermediate images or the target camera view if completed with the intermediate images). Additionally, the control module 220 also incorporates the previously generated intermediate images in addition to the original conditioning images with the scene tokens in order to provide additional information for conditioning within the model 260. These additional scene tokens from the intermediate images then function to facilitate an improved generation of a subsequent image (i.e., a subsequent intermediate image or the final multi-view image) by enforcing consistency through the progression of images generated about the scene. In any case, the control module 220 generates the scene and prediction tokens at 730 as the inputs to the model 260 for generating an image.

At 740, the control module 220 generates an output using the model 260. The output is either an intermediate image or the final multi-view image as requested in the original request depending on the progression of the generative system 170 over the intermediate steps. In general, the control module 220 generates the output in a similar manner as discussed at block 530 of the method 500. That is, the control module 220 provides the scene tokens and the prediction tokens into the model 260 and the model 260 generates the new image as an output. It should be appreciated that while the output is discussed as the multi-view image, in an alternative arrangement, the generative system 170 is capable of generating depth maps also. Thus, the generative system 170 may execute the method 700 by generating depth maps in place of multi-view images, by generating a mixture of depth maps and multi-view images, or by generating both for each step. However, for purposes of the brevity of the current discussion, the multi-view images are described.

At 750, the control module 220 determines whether to continue with iteratively generating successive images or to exit and provide the output as the final multi-view image. That is, the control module 220 iteratively generates the intermediate images in a stepwise manner through the intermediate locations/views until reaching the target camera view. When the target camera view is generated on a final iteration of blocks 720-740, the control module 220 then exits from generating additional outputs and proceeds with providing the output, as described at 760. As noted previously, the number of iterations is determined according to the number of steps into which the space is divided. Accordingly, depending on how the control module 220 divides the space between the starting points and the target camera view, the number of iterations of 720-740 will vary.

At 760, the output module 230 provides the output. As noted, the output may take different forms depending on the task embedding. However, in general, the output is multi-view image of the scene from a defined viewpoint of the target camera view. In any case, the output module 230 may use the output to control the vehicle 100 or a robotic device (e.g., robotic manipulators) according to a world model/planning view derived using the output.

In one embodiment, the output module 230 uses the output to form a planner representation of the environment that includes locations and other information about objects in the environment. The output module 230 may communicate the planner representation to the automated driving module 160 or another component within the vehicle 100 that functions to dynamically control operation of the vehicle 100 via steering, braking, and acceleration. Of course, in other arrangements, the output module 230 can use the output to render a visualization on a display in the vehicle or in another device that implements the system 170. The visualization may be provided as part of an ADAS function and can include a rendering of the scene showing the additional view provided as the output to facilitate, for example, visualizing occluded areas of a scene to improve situational awareness.

FIG. 1 will now be discussed in full detail as an example environment within which the system and methods disclosed herein may operate. In some instances, the vehicle 100 is configured to switch selectively between an autonomous mode, one or more semi-autonomous operational modes, and/or a manual mode. Such switching can be implemented in a suitable manner, now known or later developed. “Manual mode” means that all of or a majority of the navigation and/or maneuvering of the vehicle is performed according to inputs received from a user (e.g., human driver). In one or more arrangements, the vehicle 100 can be a conventional vehicle that is configured to operate in only a manual mode.

In one or more embodiments, the vehicle 100 is an autonomous vehicle. As used herein, “autonomous vehicle” refers to a vehicle that operates in an autonomous mode. “Autonomous mode” refers to navigating and/or maneuvering the vehicle 100 along a travel route using one or more computing systems to control the vehicle 100 with minimal or no input from a human driver. In one or more embodiments, the vehicle 100 is highly automated or completely automated. In one embodiment, the vehicle 100 is configured with one or more semi-autonomous operational modes in which one or more computing systems perform a portion of the navigation and/or maneuvering of the vehicle along a travel route, and a vehicle operator (i.e., driver) provides inputs to the vehicle to perform a portion of the navigation and/or maneuvering of the vehicle 100 along a travel route.

The vehicle 100 can include one or more processors 110. In one or more arrangements, the processor(s) 110 can be a main processor of the vehicle 100. For instance, the processor(s) 110 can be an electronic control unit (ECU). The vehicle 100 can include one or more data stores 115 for storing one or more types of data. The data store 115 can include volatile and/or non-volatile memory. Examples of suitable data stores 115 include RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The data store 115 can be a component of the processor(s) 110, or the data store 115 can be operatively connected to the processor(s) 110 for use thereby. The term “operatively connected,” as used throughout this description, can include direct or indirect connections, including connections without direct physical contact.

In one or more arrangements, the one or more data stores 115 can include map data 116. The map data 116 can include maps of one or more geographic areas. In some instances, the map data 116 can include information or data on roads, traffic control devices, road markings, structures, features, and/or landmarks in the one or more geographic areas. The map data 116 can be in any suitable form. In some instances, the map data 116 can include aerial views of an area. In some instances, the map data 116 can include ground views of an area, including 360-degree ground views. The map data 116 can include measurements, dimensions, distances, and/or information for one or more items included in the map data 116 and/or relative to other items included in the map data 116. The map data 116 can include a digital map with information about road geometry. The map data 116 can be high quality and/or highly detailed.

In one or more arrangements, the map data 116 can include one or more terrain maps 117. The terrain map(s) 117 can include information about the ground, terrain, roads, surfaces, and/or other features of one or more geographic areas. The terrain map(s) 117 can include elevation data in the one or more geographic areas. The map data 116 can be high quality and/or highly detailed. The terrain map(s) 117 can define one or more ground surfaces, which can include paved roads, unpaved roads, land, and other things that define a ground surface.

In one or more arrangements, the map data 116 can include one or more static obstacle maps 118. The static obstacle map(s) 118 can include information about one or more static obstacles located within one or more geographic areas. A “static obstacle” is a physical object whose position does not change or substantially change over a period of time and/or whose size does not change or substantially change over a period of time. Examples of static obstacles include trees, buildings, curbs, fences, railings, medians, utility poles, statues, monuments, signs, benches, furniture, mailboxes, large rocks, hills. The static obstacles can be objects that extend above ground level. The one or more static obstacles included in the static obstacle map(s) 118 can have location data, size data, dimension data, material data, and/or other data associated with it. The static obstacle map(s) 118 can include measurements, dimensions, distances, and/or information for one or more static obstacles. The static obstacle map(s) 118 can be high quality and/or highly detailed. The static obstacle map(s) 118 can be updated to reflect changes within a mapped area.

The one or more data stores 115 can include sensor data 119. In this context, “sensor data” means any information about the sensors that the vehicle 100 is equipped with, including the capabilities and other information about such sensors. As will be explained below, the vehicle 100 can include the sensor system 120. The sensor data 119 can relate to one or more sensors of the sensor system 120. As an example, in one or more arrangements, the sensor data 119 can include information on one or more LIDAR sensors 124 of the sensor system 120.

In some instances, at least a portion of the map data 116 and/or the sensor data 119 can be located in one or more data stores 115 located onboard the vehicle 100. Alternatively, or in addition, at least a portion of the map data 116 and/or the sensor data 119 can be located in one or more data stores 115 that are located remotely from the vehicle 100.

As noted above, the vehicle 100 can include the sensor system 120. The sensor system 120 can include one or more sensors. “Sensor” means any device, component, and/or system that can detect, and/or sense something. The one or more sensors can be configured to detect, and/or sense in real-time. As used herein, the term “real-time” means a level of processing responsiveness that a user or system senses as sufficiently immediate for a particular process or determination to be made, or that enables the processor to keep up with some external process.

In arrangements in which the sensor system 120 includes a plurality of sensors, the sensors can work independently from each other. Alternatively, two or more of the sensors can work in combination with each other. In such a case, the two or more sensors can form a sensor network. The sensor system 120 and/or the one or more sensors can be operatively connected to the processor(s) 110, the data store(s) 115, and/or another element of the vehicle 100 (including any of the elements shown in FIG. 1). The sensor system 120 can acquire data of at least a portion of the external environment of the vehicle 100.

The sensor system 120 can include any suitable type of sensor. Various examples of different types of sensors will be described herein. However, it will be understood that the embodiments are not limited to the particular sensors described. The sensor system 120 can include one or more vehicle sensors 121. The vehicle sensor(s) 121 can detect, determine, and/or sense information about the vehicle 100 itself. In one or more arrangements, the vehicle sensor(s) 121 can be configured to detect, and/or sense position and orientation changes of the vehicle 100, such as, for example, based on inertial acceleration. In one or more arrangements, the vehicle sensor(s) 121 can include one or more accelerometers, one or more gyroscopes, an inertial measurement unit (IMU), a dead-reckoning system, a global navigation satellite system (GNSS), a global positioning system (GPS), a navigation system 147, and/or other suitable sensors. The vehicle sensor(s) 121 can be configured to detect, and/or sense one or more characteristics of the vehicle 100. In one or more arrangements, the vehicle sensor(s) 121 can include a speedometer to determine a current speed of the vehicle 100.

Alternatively, or in addition, the sensor system 120 can include one or more environment sensors 122 configured to acquire, and/or sense driving environment data. “Driving environment data” includes data or information about the external environment in which an autonomous vehicle is located or one or more portions thereof. For example, the one or more environment sensors 122 can be configured to detect, quantify and/or sense obstacles in at least a portion of the external environment of the vehicle 100 and/or information/data about such obstacles. Such obstacles may be stationary objects and/or dynamic objects. The one or more environment sensors 122 can be configured to detect, measure, quantify and/or sense other things in the external environment of the vehicle 100, such as, for example, lane markers, signs, traffic lights, traffic signs, lane lines, crosswalks, curbs proximate the vehicle 100, off-road objects, etc.

Various examples of sensors of the sensor system 120 will be described herein. The example sensors may be part of the one or more environment sensors 122 and/or the one or more vehicle sensors 121. However, it will be understood that the embodiments are not limited to the particular sensors described.

As an example, in one or more arrangements, the sensor system 120 can include one or more radar sensors 123, one or more LIDAR sensors 124 (e.g., 4 beam LiDAR), one or more sonar sensors 125, and/or one or more cameras 126. In one or more arrangements, the one or more cameras 126 can be high dynamic range (HDR) cameras or infrared (IR) cameras.

The vehicle 100 can include an input system 130. An “input system” includes any device, component, system, element or arrangement or groups thereof that enable information/data to be entered into a machine. The input system 130 can receive an input from a vehicle passenger (e.g., a driver or a passenger). The vehicle 100 can include an output system 135. An “output system” includes a device, or component, that enables information/data to be presented to a vehicle passenger (e.g., a person, a vehicle passenger, etc.).

The vehicle 100 can include one or more vehicle systems 140. Various examples of the one or more vehicle systems 140 are shown in FIG. 1. However, the vehicle 100 can include more, fewer, or different vehicle systems. It should be appreciated that although particular vehicle systems are separately defined, each or any of the systems or portions thereof may be otherwise combined or segregated via hardware and/or software within the vehicle 100. The vehicle 100 can include a propulsion system 141, a braking system 142, a steering system 143, throttle system 144, a transmission system 145, a signaling system 146, and/or a navigation system 147. Each of these systems can include one or more devices, components, and/or a combination thereof, now known or later developed.

The navigation system 147 can include one or more devices, applications, and/or combinations thereof, now known or later developed, configured to determine the geographic location of the vehicle 100 and/or to determine a travel route for the vehicle 100. The navigation system 147 can include one or more mapping applications to determine a travel route for the vehicle 100. The navigation system 147 can include a global positioning system, a local positioning system, or a geolocation system.

The processor(s) 110, the generative system 170, and/or the automated driving module 160 can be operatively connected to communicate with the various vehicle systems 140 and/or individual components thereof. For example, returning to FIG. 1, the processor(s) 110 and/or the automated driving module 160 can be in communication to send and/or receive information from the various vehicle systems 140 to control the movement, speed, maneuvering, heading, direction, etc. of the vehicle 100. The processor(s) 110, the generative system 170, and/or the automated driving module 160 may control some or all of these vehicle systems 140 and, thus, may be partially or fully autonomous.

The processor(s) 110, the generative system 170, and/or the automated driving module 160 can be operatively connected to communicate with the various vehicle systems 140 and/or individual components thereof. For example, returning to FIG. 1, the processor(s) 110, the generative system 170, and/or the automated driving module 160 can be in communication to send and/or receive information from the various vehicle systems 140 to control the movement, speed, maneuvering, heading, direction, etc. of the vehicle 100. The processor(s) 110, the generative system 170, and/or the automated driving module 160 may control some or all of these vehicle systems 140.

The processor(s) 110, the generative system 170, and/or the automated driving module 160 may be operable to control the navigation and/or maneuvering of the vehicle 100 by controlling one or more of the vehicle systems 140 and/or components thereof. For instance, when operating in an autonomous mode, the processor(s) 110, the generative system 170, and/or the automated driving module 160 can control the direction and/or speed of the vehicle 100. The processor(s) 110, the generative system 170, and/or the automated driving module 160 can cause the vehicle 100 to accelerate (e.g., by increasing the supply of fuel provided to the engine), decelerate (e.g., by decreasing the supply of fuel to the engine and/or by applying brakes) and/or change direction (e.g., by turning the front two wheels). As used herein, “cause” or “causing” means to make, force, compel, direct, command, instruct, and/or enable an event or action to occur or at least be in a state where such event or action may occur, either in a direct or indirect manner.

The vehicle 100 can include one or more actuators 150. The actuators 150 can be any element or combination of elements operable to modify, adjust and/or alter one or more of the vehicle systems 140 or components thereof responsive to receiving signals or other inputs from the processor(s) 110 and/or the automated driving module 160. Any suitable actuator can be used. For instance, the one or more actuators 150 can include motors, pneumatic actuators, hydraulic pistons, relays, solenoids, and/or piezoelectric actuators, just to name a few possibilities.

The vehicle 100 can include one or more modules, at least some of which are described herein. The modules can be implemented as computer-readable program code that, when executed by a processor 110, implement one or more of the various processes described herein. One or more of the modules can be a component of the processor(s) 110, or one or more of the modules can be executed on and/or distributed among other processing systems to which the processor(s) 110 is operatively connected. The modules can include instructions (e.g., program logic) executable by one or more processor(s) 110. Alternatively, or in addition, one or more data store 115 may contain such instructions.

In one or more arrangements, one or more of the modules described herein can include artificial or computational intelligence elements, e.g., neural network, fuzzy logic, or other machine learning algorithms. Further, in one or more arrangements, one or more of the modules can be distributed among a plurality of the modules described herein. In one or more arrangements, two or more of the modules described herein can be combined into a single module.

The vehicle 100 can include one or more automated driving modules 160. The automated driving module 160 can be configured to receive data from the sensor system 120 and/or any other type of system capable of capturing information relating to the vehicle 100 and/or the external environment of the vehicle 100. In one or more arrangements, the automated driving module 160 can use such data to generate one or more driving scene models. The automated driving module 160 can determine a position and velocity of the vehicle 100. The automated driving module 160 can determine the location of obstacles, obstacles, or other environmental features including traffic signs, trees, shrubs, neighboring vehicles, pedestrians, etc.

The automated driving module 160 can be configured to receive, and/or determine location information for obstacles within the external environment of the vehicle 100 for use by the processor(s) 110, and/or one or more of the modules described herein to estimate position and orientation of the vehicle 100, vehicle position in global coordinates based on signals from a plurality of satellites, or any other data and/or signals that could be used to determine the current state of the vehicle 100 or determine the position of the vehicle 100 with respect to its environment for use in either creating a map or determining the position of the vehicle 100 in respect to map data.

The automated driving module 160 either independently or in combination with the generative system 170 can be configured to determine travel path(s), current autonomous driving maneuvers for the vehicle 100, future autonomous driving maneuvers and/or modifications to current autonomous driving maneuvers based on data acquired by the sensor system 120, driving scene models, and/or data from any other suitable source. “Driving maneuver” means one or more actions that affect the movement of a vehicle. Examples of driving maneuvers include: accelerating, decelerating, braking, turning, moving in a lateral direction of the vehicle 100, changing travel lanes, merging into a travel lane, and/or reversing, just to name a few possibilities. The automated driving module 160 can be configured to implement determined driving maneuvers. The automated driving module 160 can cause, directly or indirectly, such autonomous driving maneuvers to be implemented. As used herein, “cause” or “causing” means to make, command, instruct, and/or enable an event or action to occur or at least be in a state where such event or action may occur, either in a direct or indirect manner. The automated driving module 160 can be configured to execute various vehicle functions and/or to transmit data to, receive data from, interact with, and/or control the vehicle 100 or one or more systems thereof (e.g., one or more of vehicle systems 140).

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-7, but the embodiments are not limited to the illustrated structure or application.

The flowcharts and block diagrams in the Figures illustrate the architecture, functionality, and operation of possible implementations of systems, methods, and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. Any kind of processing system or another apparatus adapted for carrying out the methods described herein is suited. A typical combination of hardware and software can be a processing system with computer-usable program code that, when being loaded and executed, controls the processing system such that it carries out the methods described herein. The systems, components and/or processes also can be embedded in a computer-readable storage, such as a computer program product or other data programs storage device, readable by a machine, tangibly embodying a program of instructions executable by the machine to perform methods and processes described herein. These elements also can be embedded in an application product which comprises all the features enabling the implementation of the methods described herein and, which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: a portable computer diskette, a hard disk drive (HDD), a solid-state drive (SSD), a read-only memory (ROM), an erasable programmable read-only memory (EPROM or Flash memory), a portable compact disc read-only memory (CD-ROM), a digital versatile disc (DVD), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

Generally, module, as used herein, includes routines, programs, objects, components, data structures, and so on that perform particular tasks or implement particular data types. In further aspects, a memory generally stores the noted modules. The memory associated with a module may be a buffer or cache embedded within a processor, a RAM, a ROM, a flash memory, or another suitable electronic storage medium. In still further aspects, a module as envisioned by the present disclosure is implemented as an application-specific integrated circuit (ASIC), a hardware component of a system on a chip (SoC), as a programmable logic array (PLA), or as another suitable hardware component that is embedded with a defined configuration set (e.g., instructions) for performing the disclosed functions.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present arrangements may be written in any combination of one or more programming languages, including an object-oriented programming language such as Java™ Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . ” as used herein refers to and encompasses any and all possible combinations of one or more of the associated listed items. As an example, the phrase “at least one of A, B, and C” includes A only, B only, C only, or any combination thereof (e.g., AB, AC, BC or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. A generative system, comprising:
one or more processors;
a memory communicably coupled to the one or more processors and storing instructions that, when executed by the one or more processors, cause the one or more processors to:
receive a request to generate a multi-view image, the request including input data comprised of conditioning images and a target camera view for the multi-view image;
generate the multi-view image according to the conditioning images and intermediate images generated between the multi-view image and at least one of the conditioning images using a model; and
provide the multi-view image.

2. The generative system of claim 1, wherein the instructions to generate the multi-view image include instructions to iteratively generating successive ones of the intermediate images using the conditioning images and prior ones of the intermediate images as inputs to the model.

3. The generative system of claim 1, wherein the instructions to generate the multi-view image include instructions to i) identify which of the conditioning images is at a closest location to the target camera view and ii) define intermediate views between the target camera view and the closest location associated with the one of the conditioning images for generating the intermediate images.

4. The generative system of claim 3, wherein the instructions to generate the multi-view image include instructions to i) iteratively generate the intermediate images stepwise through the intermediate views until reaching the target camera view and ii) generate the multi-view image using the intermediate images and the conditioning images as conditioning inputs to the model.

5. The generative system of claim 3, wherein the instructions to identify which of the conditioning images is at the closest location to the target camera view include instructions to determine a Euclidean distance between the views associated with the conditioning images and the target camera view.

6. The generative system of claim 1, wherein the instructions to acquire the input data include instructions to acquire the conditioning images that depict a scene from different viewpoints, and
wherein the input data includes camera intrinsics associated with one or more cameras that acquire the conditioning images, and camera extrinsics for the one or more cameras.

7. The generative system of claim 1, wherein the instructions further include instructions to:
generate i) scene tokens that describe the scene according to the conditioning images and the intermediate images and ii) prediction tokens that specify a task for the model to perform, and
wherein the instructions to generate the prediction tokens include instructions to concatenate ray embeddings with a task embedding and state embeddings that include noise.

8. The generative system of claim 1, wherein the model is an attention-based diffusion architecture that decouples core computations from the dimensionality of the input data.

9. A non-transitory computer-readable medium including instructions that, when executed by one or more processors, cause the one or more processors to:
receive a request to generate a multi-view image, the request including input data comprised of conditioning images and a target camera view for the multi-view image;
generate the multi-view image according to the conditioning images and intermediate images generated between the multi-view image and at least one of the conditioning images using a model; and
provide the multi-view image.

10. The non-transitory computer-readable medium of claim 9, wherein the instructions to generate the multi-view image include instructions to iteratively generating successive ones of the intermediate images using the conditioning images and prior ones of the intermediate images as inputs to the model.

11. The non-transitory computer-readable medium of claim 9, wherein the instructions to generate the multi-view image include instructions to i) identify which of the conditioning images is at a closest location to the target camera view and ii) define intermediate views between the target camera view and the closest location associated with the one of the conditioning images for generating the intermediate images.

12. The non-transitory computer-readable medium of claim 11, wherein the instructions to generate the multi-view image include instructions to i) iteratively generate the intermediate images stepwise through the intermediate views until reaching the target camera view and ii) generate the multi-view image using the intermediate images and the conditioning images as conditioning inputs to the model.

13. The non-transitory computer-readable medium of claim 11, wherein the instructions to identify which of the conditioning images is at the closest location to the target camera view include instructions to determine a Euclidean distance between the views associated with the conditioning images and the target camera view.

14. A method, comprising:
receiving a request to generate a multi-view image, the request including input data comprised of conditioning images and a target camera view for the multi-view image;
generating the multi-view image according to the conditioning images and intermediate images generated between the multi-view image and at least one of the conditioning images using a model; and
providing the multi-view image.

15. The method of claim 14, wherein generating the multi-view image includes iteratively generating successive ones of the intermediate images using the conditioning images and prior ones of the intermediate images as inputs to the model.

16. The method of claim 14, wherein generating the multi-view image includes i) identifying which of the conditioning images is at a closest location to the target camera view and ii) defining intermediate views between the target camera view and the closest location associated with the one of the conditioning images for generating the intermediate images.

17. The method of claim 16, wherein generating the multi-view image includes i) iteratively generating the intermediate images stepwise through the intermediate views until reaching the target camera view and ii) generating the multi-view image using the intermediate images and the conditioning images as conditioning inputs to the model.

18. The method of claim 16, wherein identifying which of the conditioning images is at the closest location to the target camera view includes determining a Euclidean distance between the views associated with the conditioning images and the target camera view.

19. The method of claim 14, wherein acquiring the input data includes acquiring the conditioning images that depict a scene from different viewpoints, and
wherein the input data includes camera intrinsics associated with one or more cameras that acquire the conditioning images, and camera extrinsics for the one or more cameras.

20. The method of claim 14, further comprising:
generating i) scene tokens that describe the scene according to the conditioning images and the intermediate images and ii) prediction tokens that specify a task for the model to perform,
wherein the model is an attention-based diffusion architecture that decouples core computations from the dimensionality of the input data, and
wherein generating the prediction tokens includes concatenating ray embeddings with a task embedding and state embeddings that include noise.
